(19) United States
(12) Patent Application Publication
(10) Pub. No.: US 2011/0200303 A1
(43) Pub. Date: Aug. 18, 2011

(54) Method of Video Playback

(75) Inventors: Jose Carlos Pujol Alcolado, Barcelona (ES); Jose Luis Landabaso Diaz, Barcelona (ES); Nicolas Herrero Molina, Barcelona (ES)

(73) Assignee: TELEFONICA, S.A., Madrid (ES)

(21) Appl. No.: 12/879,266

(22) Filed: Sep. 10, 2010

Related U.S. Application Data
(60) Provisional application No. 61/303,852, filed on Feb. 12, 2010.

(51) Int. Cl. H04N 9/80

(52) U.S. Cl. 386/248; 386/E05.001

(57) ABSTRACT

A non-transitory computer readable storage medium includes a computer-readable code for executing a method of video playback, capable of displaying a video file in a three-dimensional environment (2) from any perspective, by projecting two-dimensional frames (1) of the video file on said environment (2), according to a position and perspective assigned to the frame (1).

### CROSS-REFERENCE TO RELATED APPLICATIONS

This application is non-provisional counterpart to and claims priority from U.S. Ser. No. 61/303,852 filed on Feb. 12, 2010, which is pending and which is incorporated by reference in its entirety for all purposes.

### FIELD OF THE INVENTION

The present invention has its application within the sector of video playback, especially, in the field of three-dimensional video displaying.

### BACKGROUND OF THE INVENTION

Since traditional Video Home System (VHS), video players include user interfaces which allow to control the playback time of the video, from the classic interface of play/pause, fast-forward, and rewind buttons, to more recent interfaces which allow to jump to a selected playback time.

On the other hand, the development tools for creating three-dimensional (3D) structure, allows to display a single scenario from different points of view. In the case of static scenarios (that is, three-dimensional images), existing solutions are known which allow the user to select his or her desired point of view, thus allowing to navigate through the space of the scenario.

However, when dealing with non-static three-dimensional scenarios, that is, with 3D videos, the point of view is usually defined by the video creation tool. This point of view may be static or change over time, but once it is defined and the video is created, it cannot be changed by a user at the playback stage.

3D video games are an exception, as they usually allow the user to dynamically modify the point of view in the 3D environment, directly, or by moving a character through said scenario. However, video games cannot be regarded as video playback as they lack the possibility of navigating through time, that is, of selecting a playback time among a plurality of video frames to be reproduced.

Thus, there is no solution in the state of the art which allows to navigate a video file both in time and in space, that is, which allows to select both the playback time and the point of view from which the images corresponding to said playback time are displayed.

### SUMMARY OF THE INVENTION

The current invention solves the aforementioned problems by disclosing a method capable of displaying a two-dimensional (2D) video with a three-dimensional (3D) environment model attached, with an arbitrary point of view.

In a first aspect of the present invention, a method of video playback is disclosed. The method requires two basic inputs to perform the video playback:
A 2D video file, which stores playback information for a plurality of video frames (1), each frame (1) having a unique playback time which determines the order in which the frames are displayed, and which allows to perform playback operations in which current playback time is modified (such as fast-forward or a simple playback time selection).
A 3D environment model (2), which can be either static or dynamic. In the case of a dynamic 3D environment model, there is a model for each playback time, attached to the playback time of the 2D video file. In the case of static environment models, the model remains unchanged for the duration of the video. The 3D model (2) may be, for example, a representation of the scenario in which the video was originally recorded, or a fictitious scenario designed for said display.

The first step of the disclosed method, prior to the playback of the file, is assigning to each frame (1) of the video a position and a perspective in the three dimensional model (2). The position and perspective of a frame may correspond, for example, to a position and perspective of a recording device which originally recorded the video.

Once each frame (1) has an assigned position and perspective, the method is able to determine the image to be displayed for a given playback time by performing the following steps:
Determining an area of the 3D model (2) to be visualized, that is, determining the point of view to be displayed. Some preferred options for this point of view are a point of view arbitrarily selected by a user and a point of view which correspond to the position associated to the frame, but with a broader display angle (which means that the frame (1) is displayed without any modification, but a part of the 3D model (2) is also visualized around the frame). Preferably, the method comprises receiving commands to switch at any given playback time between the aforementioned points of view, and also preferably, between said points of view and a traditional 2D playback (understanding by traditional 2D playback any display of 2D video frames which do not include a 3D environment). While switching between all the playback modes and point of views, the temporal relation is maintained, that is, a playback mode switch does not imply any change in the playback time, thus allowing seamless transitions between modes.
Projecting the frame (1) with said given playback time according to the point of view to be displayed This projection is performed according to the position and perspective assigned to the frame (1), thus giving a location in the 3D environment to the images shown by the frame (1).
Finally, displaying the area of the 3D model (2) to be visualized, including any part of the frame projected to that area. In other words, the combination of the 3D model (2) and the projected frame (1) are displayed from the selected point of view.

In another aspect of the present invention, a computer program is disclosed, comprising computer program code means adapted to perform the steps of the described method, when said program is run on a computer, a digital signal processor, a field-programmable gate array, an application-specific integrated circuit, a micro-processor, a micro-controller, or any other form of programmable hardware.

With both the disclosed method and computer program, a user is able to navigate through the video file in both time and space, performing not only the usual playback operations (such as play, pause, fast-forward, playback time selection, etc. . . . ), but also dynamically selecting the point of view from which the video is displayed.

These and other advantages will be apparent in the light of the detailed description of the invention.

### BRIEF DESCRIPTION OF THE DRAWINGS

For the purpose of aiding the understanding of the characteristics of the invention, according to a preferred practical embodiment thereof and in order to complement this description, the following figures are attached as an integral part thereof, having an illustrative and non-limiting character:

FIG. 1 shows an schematic example of a video frame.

FIG. 2 depicts the visualization of a video frame in a 3D environment model according to a preferred embodiment of the method of the invention.

FIG. 3 shows an alternative visualization mode of the frame in the 3D environment according to another preferred embodiment of the method of the invention.

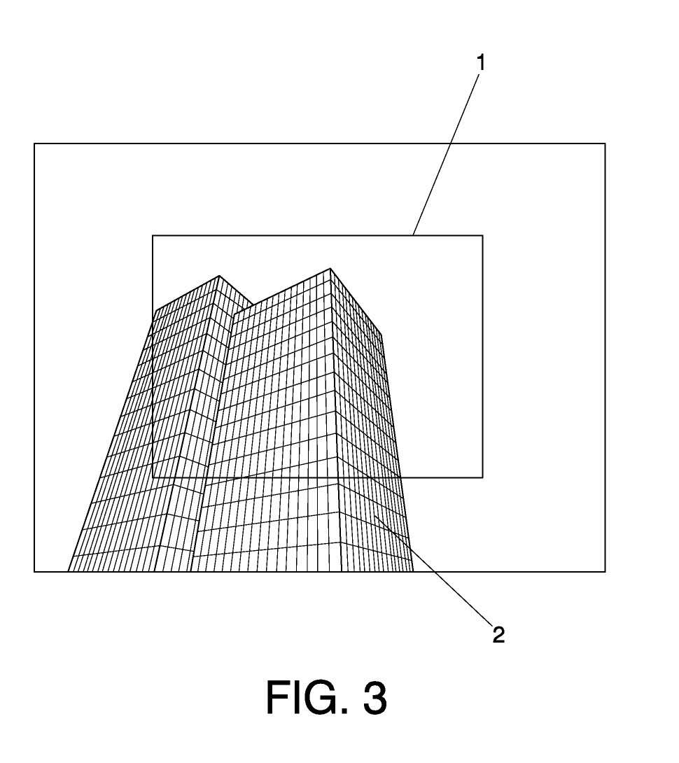

### DETAILED DESCRIPTION OF THE INVENTION

The matters defined in this detailed description are provided to assist in a comprehensive understanding of the invention. Accordingly, those of ordinary skill in the art will recognize that variations, changes and modifications of the embodiments described herein can be made without departing from the scope and spirit of the invention.

Note that in this text, the term “comprises” and its derivations (such as “comprising”, etc.) should not be understood in an excluding sense, that is, these terms should not be interpreted as excluding the possibility that what is described and defined may include further elements, steps, etc.

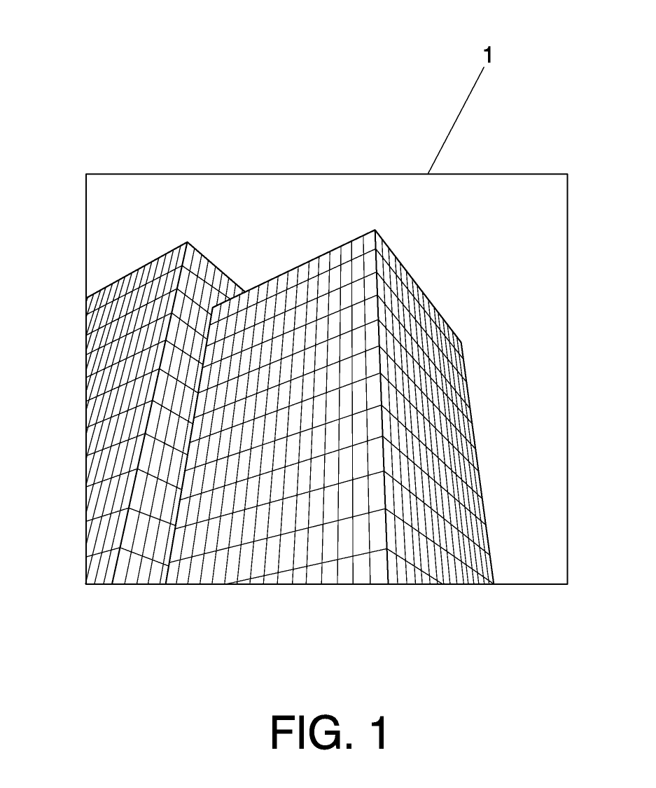

FIG. 1 shows an example of a 2D video frame 1 of a video file. In a traditional video playback system, said video frame 1 is the only information displayed, thus having a fixed point of view which cannot be modified by the user.

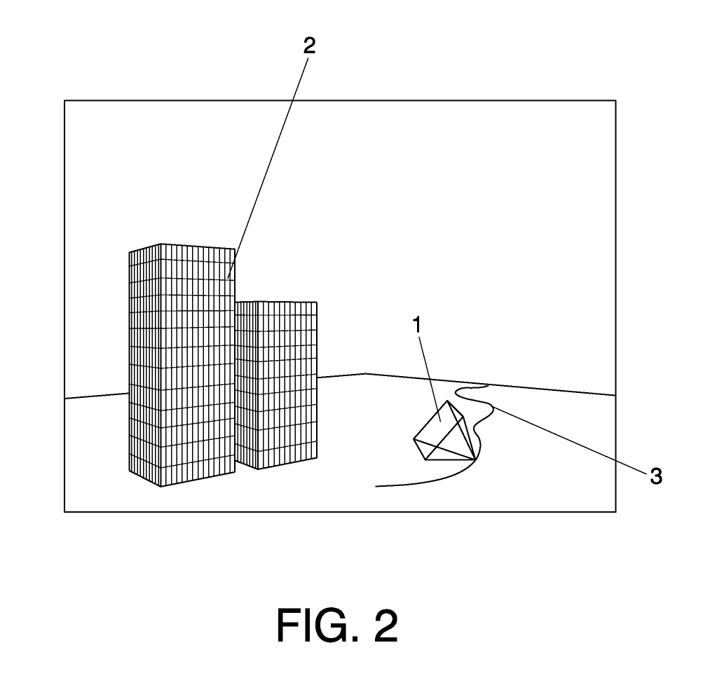

FIG. 2 shows a schematic representation of a first visualization mode, in which the same frame 1 is displayed along with the corresponding 3D environment for a given playback time, and on which the point of view is freely determined by the user (for example, by using buttons to move a virtual camera in the three coordinates of the Cartesian space, and also to tilt said camera; or by using any other alternative interface which allows the user to modify the point of view). Note that the 3D environment model can either be static or dynamic, meaning that it can either remain constant for the duration of the video, or vary depending of the playback time.

In order to perform the projection of the frame 1, a position and perspective is assigned to the frame. In this example, these position and perspective are assigned according to stored positioning data of the camera which recorded the video. As the camera moves along a route 1, position and perspective vary from one frame to another.

Note that the way of obtaining the position and perspective assigned to each frame is not limited to positioning data of a recording device. For example, it can be easily achieved if the video is developed by a 3D model building tool using virtual cameras whose positions and movements are known, or by using any other process such as automatically mapping a frame to the 3D environment by using similarity measurements.

As the projection of the video frame 1, depends of the playback time of the frame, a four-dimensional structure is created (three spatial dimensions plus time). According to the method, a user can simultaneously navigate through all four of these dimensions, that means that he or she is able to, for example, modify the point of view without stopping the video playback, or to choose a different playback time while keeping a selected point of view.

The information of position and perspective of frame 1 allows a second visualization mode, as shown on FIG. 2. In this second mode, the point of view is such that the original frame 1 is displayed in the centre of the visualization area, which also includes a part of the surrounding 3D model 2. In this case, the point of view corresponds to the same position assigned to the frame 1, but with a broader angle.

As changing modes only requires to change the point of view, modes can be switched at any time without stopping the playback of the video. This also allows to seamlessly change to a traditional 2D playback, in which only the video frame 1 is displayed. As this switching operation does not affect the playback time, the user can continue to watch the video at the same playback time which was being displayed.

Also, with all the described visualization modes, a user is able to modify the playback time, for example, by means of a classic interface with fast-forward and back buttons, or to choose a particular playback time.

The present invention may embodied in a non-transitory computer readable storage medium (such as compact disk, a DVD, or other media) and includes a computer-readable code for executing the method for video playback and/or image processing.

1. A non-transitory computer readable storage medium comprising:
a computer-readable code for executing a method of video playback, wherein the video comprises a plurality of two-dimensional frames (1), each frame (1) having an assigned playback time, characterized in that the method comprises:
assigning to each frame (1) of the video a position and perspective in a three-dimensional environment model (2); the method comprising:
for a given playback time:
determining an area of the three-dimensional model (2) to be visualized;
projecting the frame (1) with said given playback time on the three-dimensional model (2) according to the position and perspective assigned to said frame (1);
displaying the area to be visualized of the three-dimensional model (3) with the projected frame (1).

2. The storage medium according to claim 1 characterized in that the playback time is determined by means of user commands.

3. The storage medium according to claim 1 characterized in that the area to be visualized is determined by means of user commands.

4. The storage medium according to claim 1 characterized in that, for a given playback time, the area to be visualized corresponds to a perspective from the position associated to the frame (1) with said given playback time, being the area to be visualized wider than the projection of said frame (1).

5. The storage medium according to claim 1 characterized in that the method comprises receiving user commands to switch the area to be visualized between:
a first area determined by user commands,
a second area corresponding to a perspective from the position associated to a frame (1) being played, being the area to be visualized wider than the projection of said frame (1); and in that the area to be visualized is switched keeping the playback time unchanged.

6. The storage medium according to claim 1 characterized in that the method comprises receiving user commands to switch to a two-dimensional playback mode in which, for a given playback time, only the two-dimensional frame (1) with said given playback time is displayed, and in that when switching to the two dimensional playback mode, the playback time is kept unchanged.

7. A computer program comprising:
a non-transitory computer readable storage medium comprising
a computer-readable code for executing a method of video playback, wherein the video comprises a plurality of two-dimensional frames (1), each frame (1) having an assigned playback time, characterized in that the method comprises:
assigning to each frame (1) of the video a position and perspective in a three-dimensional environment model (2); the method comprising:
for a given playback time:
determining an area of the three-dimensional model (2) to be visualized;
projecting the frame (1) with said given playback time on the three-dimensional model (2) according to the position and perspective assigned to said frame (1);
displaying the area to be visualized of the three-dimensional model (3) with the projected frame (1).
said program running on a computer, a digital signal processor, a field-programmable gate array, an application-specific integrated circuit, a micro-processor, a micro-controller, or any other form of programmable hardware.
